(19) United States
(12) Patent Application Publication
(10) Pub. No.: US 2014/0098337 A1
(43) Pub. Date: Apr. 10, 2014

(54) Eyeglasses

(71) Applicant: Lin-Yun Chen, Tainan City (TW)

(72) Inventor: Lin-Yun Chen, Tainan City (TW)

(21) Appl. No.: 13/644,452

(22) Filed: Oct. 4, 2012

(51) Int. Cl. G02C 5/22

(52) U.S. Cl. 351/153

(57) ABSTRACT

A pair of eyeglasses includes a frame, two lenses, two temples, two push devices and two fixing elements. The frame has two lens-holding portions, to which the lens are respectively disposed. The temples are respectively connected with two sides of the frame. Each of the push devices is connected to the frame and the corresponding temple, and has a track at an end thereof. The fixing elements are respectively disposed at the tracks, and each of the fixing elements connects the frame, the corresponding temple and push device. Each of the push devices moves relative to the frame through the track thereof By the deposition of the push devices, the lenses can be easily fixed to the frame and unloaded from the frame, thereby improving the usability and extending the lifespan of the product.

### BACKGROUND OF THE INVENTION

1. Field of the Invention

The invention relates to a pair of eyeglasses.

2. Description of the Prior Art

In general, a pair of eyeglasses mainly includes a frame and two temples that are respectively pivoted on two sides of the frame. The frame includes two rims, and the inner edge of each of the rims has a slot to hold the corresponding lens. Accordingly, the sidewalls of the slot can block the lenses to prevent them from leaving the frame. In this case, however, the lens needs to be hard pressed into the slot to be fixed to the frame although the frame is a little flexible. Therefore, the lens is easily broken during the assembly due to the brittleness of the lens, and the frame is also easily damaged.

### SUMMARY OF THE INVENTION

In view of the foregoing problems, an objective of the invention is to provide a pair of eyeglasses whose lenses can be fixed and unloaded easily so as to improve the usability and extend the lifespan of the product.

To achieve the above objective, a pair of eyeglasses includes a frame, two lenses, two temples, two push devices and two fixing elements. The frame has two lens-holding portions, to which the lens are respectively disposed. The temples are respectively connected with two sides of the frame. Each of the push devices is connected to the frame and the corresponding temple, and has a track at an end thereof. The fixing elements are respectively disposed at the tracks, and each of the fixing elements connects the frame, the corresponding temple and push device. Each of the push devices moves relative to the frame through the track thereof.

In one embodiment, at least a side of the lens is fixed to the lens-holding portion.

In one embodiment, an edge of the lens has an indentation, the push device has a protrusion, when the push device is disposed at a first location, the indentation connects the protrusion, and when the push device is disposed at a second location, the indentation is separate from the protrusion.

In one embodiment, the fixing element passes through the temple, the frame and the track to connect the temple, the frame and the push device.

In one embodiment, the push device and the frame each has a magnet socket, a plurality of magnets are respectively disposed at the magnet sockets, when the push device is disposed at a first location, the magnets are disposed adjacent to each other, and when the push device is disposed at a second location, the magnets are separate from each other.

In one embodiment, the magnets have a contacting surface, which is not parallel with a direction of the track.

In one embodiment, the direction of the track is linear or curviform.

In one embodiment, an inner edge of the lens-holding portion has at least a slot to fix the lens.

In one embodiment, the lens-holding portion only holds partial perimeter of the lens.

In one embodiment, the eyeglasses are sunglasses, working eyeglasses, nearsighted eyeglasses, farsighted spectacles, or presbyopic glasses.

As mentioned above, the eyeglasses of the invention have two push devices, each of which is connected with the frame and the corresponding temple and has a track at an end thereof. Besides, the fixing element can be disposed at the track to connect the frame, the corresponding temple and push device. Thereby, the push device can move relative to the frame through the track. For example, when the push device is at a first location, the lens can be fixed, and when the push device is at a second location, the lens can be taken off. Therefore, by the deposition of the push devices, the lenses can be easily fixed to the frame and taken off from the frame, thereby improving the usability and extending the lifespan of the product.

### BRIEF DESCRIPTION OF THE DRAWINGS

FIGS. 1 and 2 are schematic diagrams, in different visual angles, of a pair of eyeglasses of a preferred embodiment of the invention;

FIG. 3 is an exploded diagram of the eyeglasses of a preferred embodiment of the invention;

FIGS. 4 and 5 are schematic diagrams showing that the push device is pushed by a user so that the push device is moved to different locations through the track; and

FIG. 6 is a schematic diagram of the lens leaving from the frame when the push device is moved to the second location.

### DETAILED DESCRIPTION OF THE INVENTION

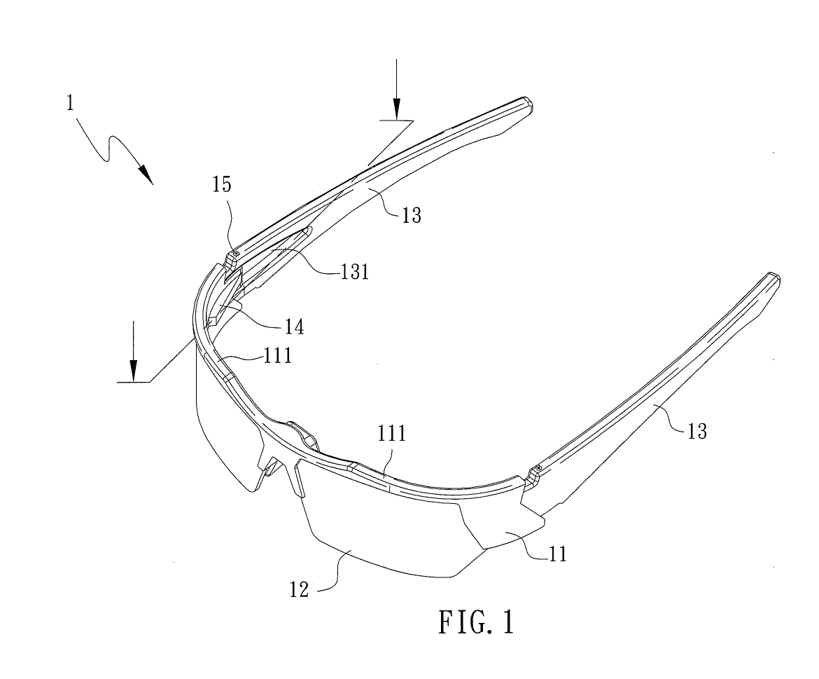

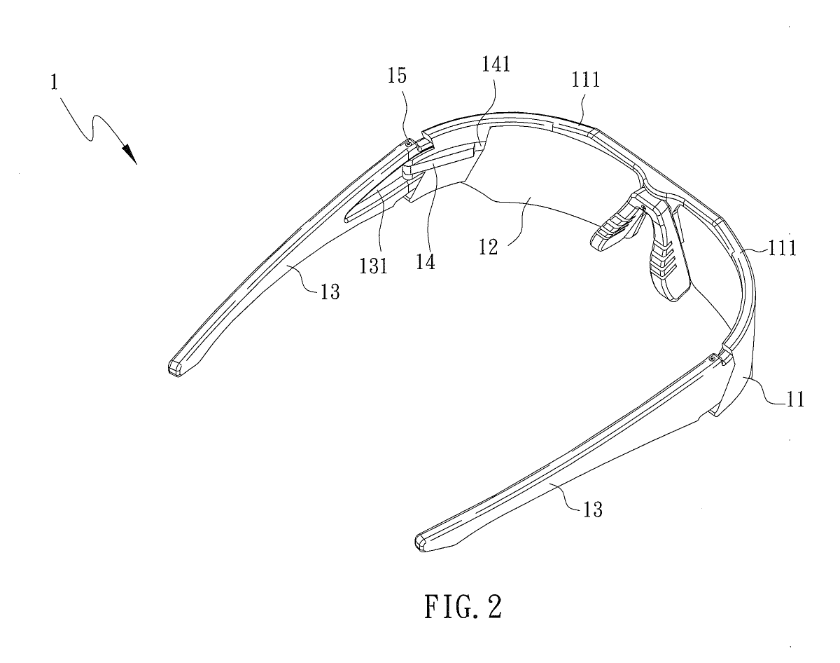

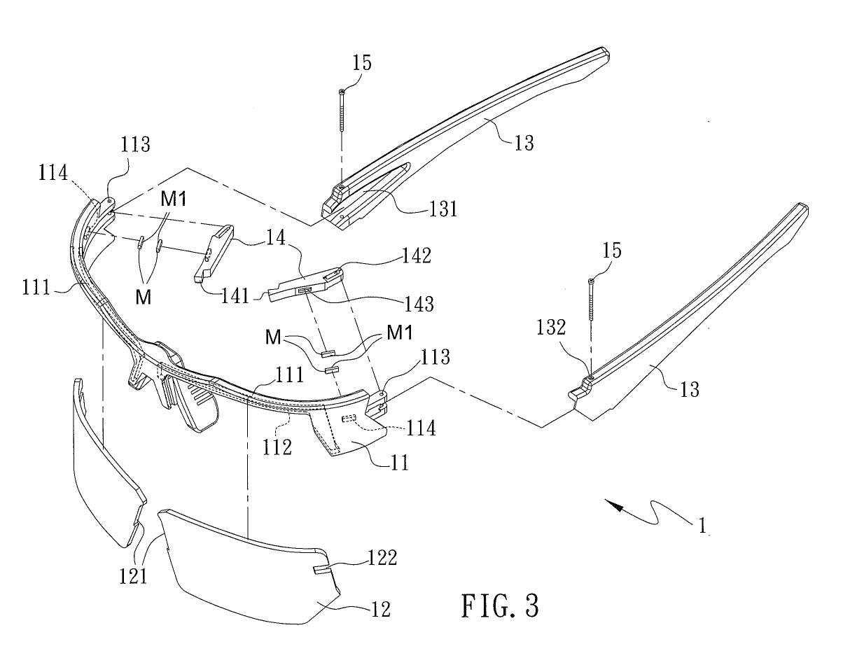

FIGS. 1 and 2 are schematic diagrams, in different visual angles, of a pair of eyeglasses 1 of a preferred embodiment of the invention, and FIG. 3 is an exploded diagram of the eyeglasses 1. Referring to FIGS. 1 to 3, the eyeglasses 1 include a frame 11, two lenses 12, two temples 13, two push devices 14, and two fixing elements 15. In the invention, the eyeglasses 1 are not limited in type, which can be sunglasses, working eyeglasses, nearsighted eyeglasses, farsighted spectacles, presbyopic glasses, or the like.

The frame 11 functions as the main part of the eyeglasses 1. The frame 11 of this embodiment is not limited in shape or curvature, both of which can be changed according to the practical requirements. The frame 11 is also not limited in material, which can be made by, for example, metal, alloy, or plastics. The frame 11 has two lens-holding portions 111, and the lenses 12 are held by the lens-holding portions 111 respectively. In the embodiment, the two lens-holding portions 111 are symmetrically disposed. The lens-holding portion 111 only holds partial perimeter of the lens, and that is, the lens-holding portion 111 is not a circular form here. An inner edge of the lens-holding portion 111 has at least one slot 112 for holding the lens 12 so that at least a side of the lens 12 is fixed to the lens-holding portion 111. Besides, the two sides of the frame 11 each has a plurality of holes 113 through which the fixing element 15 can fix the frame 11.

In the embodiment, the lens 12 is not limited in type, which can be a nearsighted lens, a farsighted lens, a multi-focus lens, a filter lens, or the like. The lens 12 has a recess 121 that is to be fixed to the lens-holding portion 111 for further enhancing the structural strength. Herein, the recess 121 is disposed on a side of the lens 12 closer to the center of the frame 11. Besides, an edge of the lens 12 has an indentation 122, and an end of the push device 14 has a protrusion 141. The indentation 122 and the protrusion 141 can be connected together.

Two temples 13 are respectively connected to the two sides of the frame 11 and used to be laid on the user's ears. In the embodiment, the temples 13 are not limited in shape and material. For example, each of the temples 13 can have a hook or no hook, and it can be made by metal, alloy, or plastics for example. A side of the temple 13 closer to the frame 11 has a depression 131 and a plurality of holes 132. The depression 131 can accommodate a portion of the push device 14. The hole 132 can be passed through by the fixing element 15 for the fixing, and accordingly, the temple 13 can rotate around the fixing element 15 as an axis.

Each of the push devices 14 connects the frame 11 and the corresponding temple 13, and has a track 142 at an end thereof. The fixing elements 15 are respectively disposed at the tracks 142, and each of the fixing elements 15 connects the frame 11, and the corresponding temple 13 and push device 14. Herein, the fixing element 15 passes through the holes 132 of the temple 13, the holes 113 of the frame 11, and the track 142 to connect the frame 13, the temple 11 and the push device 14. Thereby, the temple 13 can rotate around the fixing element 15, relative to the frame 11. Besides, each of the push devices 14 also can move relative to the frame 11 through the track 142. The track 142 can be a linear form, curviform, or other forms, and herein is instanced as a linear form.

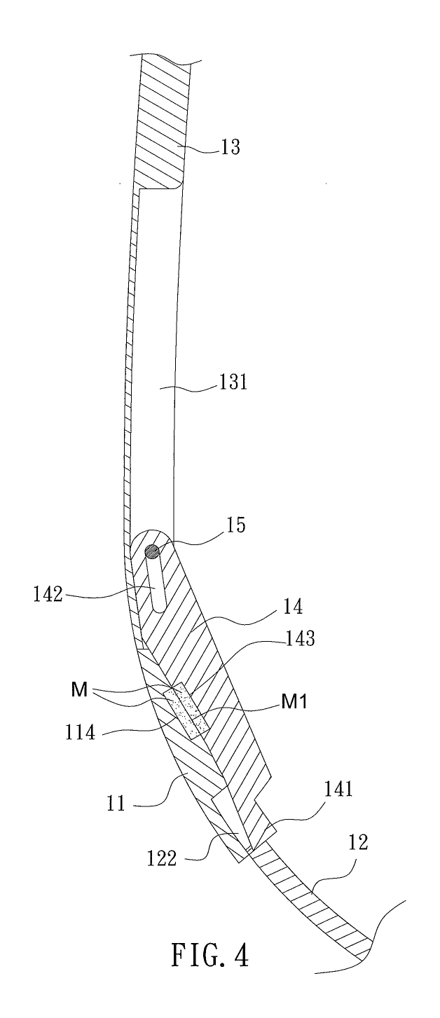

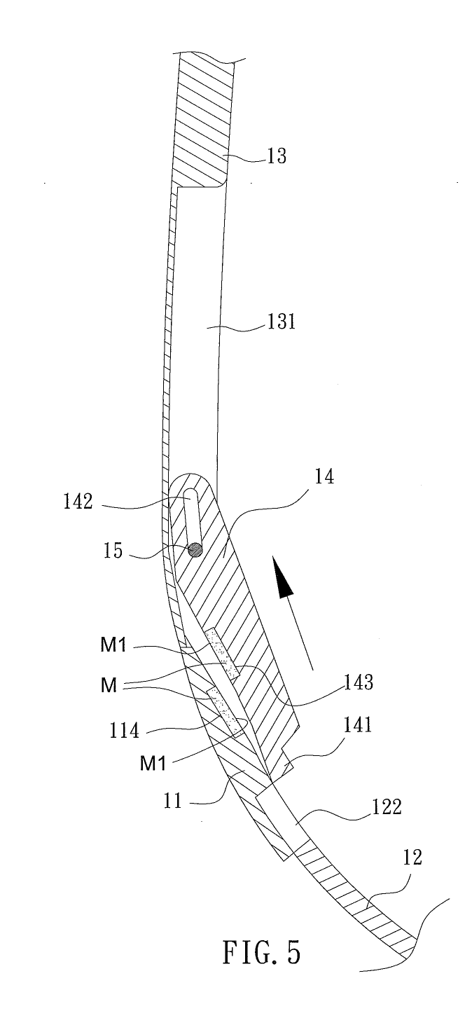

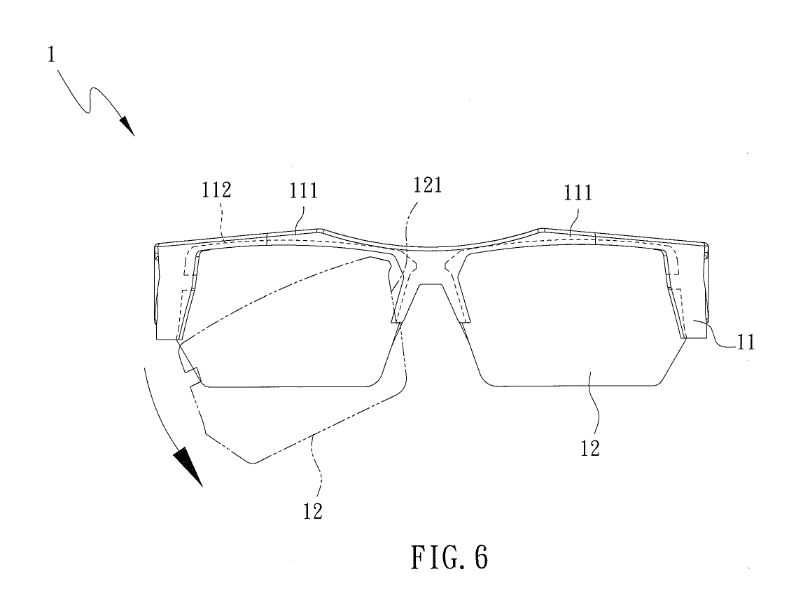

FIGS. 4 and 5 are schematic diagrams showing that the push device 14 is pushed by a user so that the push device 14 is moved to different locations through the track 142. FIG. 4 shows the push device 14 is moved to a first location, and FIG. 5 shows the push device 14 is moved to a second location. As shown in FIG. 4, when the push device 14 is located at the first location, the indentation 122 of the lens 12 is connected with the protrusion 141 of the push device 14 so that the lens is fixed. As shown in FIG. 5, when the push device 14 is pushed by the user to the second location, the protrusion 141 of the push device 14 leaves the indentation 122 of the lens 12 so that the lens 12 becomes the state as shown in FIG. 6. Thereby, the user can easily take off the lens 12 from the frame 11. On the contrary, in the case of fitting the lens 12 to the frame 11, the lens is fixed to the lens-holding portion 111 first, and then the push device 14 is pushed to the first location from the second location so that the protrusion 141 of the push device 14 is connected to the indentation 122 of the lens 12. Thereby, the lens 12 can be fixed firmly.

Besides, referring to FIGS. 3 to 5, the push device 14 and the frame 11 can have magnet sockets 143 and 114 respectively, and a plurality of magnets M are disposed in the magnet sockets 143 and 114 respectively. When the push device 14 is moved to the first location, the magnets M are disposed adjacent to each other and attract each other, as shown in FIG. 4. When the push device 14 is pushed to the second location, the magnets M are separate from each other, as shown in FIG. 5. But in this case, if the user drops the push device 14, the push device 14 will come back to the first location by the magnetic attraction of the magnets M. Besides, as shown in FIGS. 4 and 5, in the embodiment, the magnets M have a contacting surface M1, which is not parallel with the track 142 (e.g. a direction of the track). Thereby, the user can save labor to push the push device 14 to the second location, and the push device 14 can more easily come back to the first location by the attraction of the magnets M.

In summary, the eyeglasses of the invention have two push devices, each of which is connected with the frame and the corresponding temple and has a track at an end thereof. Besides, the fixing element can be disposed at the track to connect the frame, the corresponding temple and push device. Thereby, the push device can move relative to the frame through the track. For example, when the push device is at a first location, the lens can be fixed, and when the push device is at a second location, the lens can be taken off. Therefore, by the deposition of the push devices, the lenses can be easily fixed to the frame and taken off from the frame, thereby improving the usability and extending the lifespan of the product.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A pair of eyeglasses, comprising:
a frame having two lens-holding portions;
two lenses respectively held by the lens-holding portions;
two temples respectively connected with two sides of the frame;
two push devices, each of which is connected with the frame and the corresponding temple, and has a track at an end thereof; and
two fixing elements respectively disposed at the tracks, wherein each of the fixing elements connects the frame, the corresponding temple and push device, and each of the push devices moves relative to the frame through the track thereof.

2. The eyeglasses as recited in claim 1, wherein at least a side of the lens is fixed to the lens-holding portion.

3. The eyeglasses as recited in claim 1, wherein an edge of the lens has an indentation, the push device has a protrusion, when the push device is disposed at a first location, the indentation connects the protrusion, and when the push device is disposed at a second location, the indentation is separate from the protrusion.

4. The eyeglasses as recited in claim 1, wherein the fixing element passes through the temple, the frame and the track to connect the temple, the frame and the push device.

5. The eyeglasses as recited in claim 1, wherein the push device and the frame each has a magnet socket, a plurality of magnets are respectively disposed at the magnet sockets, when the push device is disposed at a first location, the magnets are disposed adjacent to each other, and when the push device is disposed at a second location, the magnets are separate from each other.

6. The eyeglasses as recited in claim 5, wherein the magnets have a contacting surface, which is not parallel with a direction of the track.

7. The eyeglasses as recited in claim 1, wherein the direction of the track is linear or curviform.

8. The eyeglasses as recited in claim 1, wherein an inner edge of the lens-holding portion has at least a slot to fix the lens.

9. The eyeglasses as recited in claim 1, wherein the lens-holding portion only holds partial perimeter of the lens.

10. The eyeglasses as recited in claim 1, wherein the eyeglasses are sunglasses, working eyeglasses, nearsighted eyeglasses, farsighted spectacles, or presbyopic glasses.
